(19) United States
(12) Patent Application Publication
(10) Pub. No.: US 2023/0085416 A1
(43) Pub. Date: Mar. 16, 2023

(54) VIBRATION DAMPER FOR A VEHICLE STEERING WHEEL

(71) Applicant: Vibracoustic SE, Darmstadt (DE)

(72) Inventors: Markus Dürre, Neuenburg am Rhein (DE); Tim Fricker, Kandern (DE); Frederik Götz, Breisach (DE); Frank Willin, Ballrechten-Dottingen (DE)

(21) Appl. No.: 17/794,305

(22) PCT Filed: Dec. 1, 2020
(86) PCT No.: PCT/EP2020/084102

§ 371 Date: Jul. 21, 2022

(30) Foreign Application Priority Data
Jan. 22, 2020 (DE) 10 2020 101 465.1

(51) Int. Cl. B62D 7/22; F16F 7/108; B60R 21/203

(52) U.S. Cl. CPC B62D 7/222; B60R 21/2037; F16F 7/108

(57) ABSTRACT

A vibration damper for a motor vehicle steering wheel may comprise a gas generator for a steering wheel airbag as an inertial mass. In embodiments, the vibration damper comprises a substantially hollow-cylindrical or hollow-frustoconical resilient element which includes an elastomer material and which can be connected to the motor vehicle steering wheel and/or a motor vehicle steering wheel module, and a carrier ring which is connected to the resilient element and which can be connected to the gas generator. In embodiments, the resilient element and the carrier ring are in the form of separate components and/or the resilient element is in the form of a monolithic molded rubber component.

### CROSS-REFERENCE TO RELATED APPLICATIONS

This application is a National Stage Patent Application of International Patent Application No. PCT/EP2020/084102, filed Dec. 1, 2020, which claims the benefit of German Application Serial No. 10 2020 101 465.1, filed Jan. 22, 2020, the contents of each are incorporated by reference in their entireties.

### TECHNICAL FIELD

Embodiements of the invention relate to vibration dampers, including vibration dampers for use with a steering wheel for a vehicle.

### BACKGROUND

Vibration dampers are used in motor and utility vehicles to absorb and counteract vibrations in the region of the steering wheel. The vibrations which occur in these vehicles during travel, or also when stationary with a running engine, can be transmitted to the steering column and from there to the steering wheel. A steering wheel which thereby vibrates may however, be perceived to be unpleasant by users. In order to counteract these vibrations on the steering wheel and to improve the travel comfort, vibration dampers can be fitted either directly on the steering column or in the steering wheel below an airbag module which may be located there. Steering wheels which include the airbag module or also the gas generator as an oscillating weight for the vibration damper are also known.

Previously known vibration dampers, for example, those described in DE 10 2004 038 023 B4, have at least one resilient element which is made of an elastomer material and to which other attachments, for example, a receiving flange and/or a securing flange, are each formed from a different material from the resilient element, for example, from a metal alloy, chemically bonded and/or vulcanized in a positive-locking manner, wherein these embodiments are produced in a vulcanization tool. This is because previously known vibration dampers are in most cases connected to the receiving flange by means of a first connection which is produced by means of vulcanization in order to carry the gas generator and connected to a securing flange by means of a second connection which is produced by means of vulcanization in order to be secured to a module base of the steering wheel and/or orientated during installation. Therefore, previously known attachments and resilient elements are connected to each other in a non-separable, materially engaging and/or positive-locking manner and form, although potentially made of different materials, a single-piece element.

Such vibration dampers are, however, complex to produce since a degree of automation is low in that the attachments have to be placed manually in the corresponding tool for vulcanization.

In addition, attachments and where applicable also the resilient elements of previously known vibration dampers have complex geometries since they must have fixing locations, such as holes and undercuts for a permanent retention. The attachments must additionally be produced in a very precise manner and therefore have small dimension tolerance limits in order to prevent an incorrect vulcanization as a result of undesirable material flow. In addition, the attachments must for the same reason be positioned and sealed in a very precise manner in the vulcanization tool. Suitable production tools are correspondingly complex and expensive.

### SUMMARY

An aspect of the disclosure is to provide a vibration damper which at least partially overcomes disadvantages of the prior art, can be produced in a simpler manner, is constructed in a less complex manner, and enables a higher degree of automation during the production thereof.

Aspects and features of embodiments of the invention are disclosed herein.

According to embodiments of the invention, a vibration damper for a motor vehicle steering wheel may comprise a gas generator for a steering wheel airbag as an inertial mass, wherein the vibration damper comprises a substantially hollow-cylindrical or hollow-frustoconical resilient element which is made of an elastomer material and which can be connected to the motor vehicle steering wheel and/or a motor vehicle steering wheel module, and a carrier ring which is connected to the resilient element and which can be connected to the gas generator. In embodiments, resilient element and the carrier ring are in the form of a separate components and/or the resilient element is in the form of a monolithic molded rubber component.

By means of vibration dampers according to embodiments, for the production thereof mostly metal attachments no longer have to be placed in a tool prior to a vulcanization of the resilient element made from an elastomer material. Connecting attachments to the resilient element is moved to a time after the vulcanization of the resilient element. Human handling errors during the production, the number of error sources per se and the costs of production and primary assembly are thereby reduced. The costs for a secondary assembly can also be considerably reduced. At the same time, however, the design and construction scopes increase since, for example, molding cavities for the vulcanization which have undercuts can be selected since removal from the mold is considerably facilitated and where applicable first enabled as a result of the absence of metal and therefore rigid attachments.

It is also advantageous that the molding complexity of the resilient element and the attachments is considerably lower since they no longer have to have apparatuses for a positive-locking engagement during the vulcanization.

The carrier ring is as a separate element at least not vulcanized to the resilient element although both elements may form a first connection to each other. The carrier ring can also dispense with positive-locking holes since, during casting of the resilient element in the vulcanization tool, no connection to the carrier ring takes place. The resilient element may form a sub-assembly with the carrier ring.

The term “monolithic” in the context herein is intended to be understood to refer to elements which comprise a single piece and which are produced from one piece. The term “separate” in the context of the disclosure is intended to be understood to apply to elements which are produced individually per se and separately from each other. The term “single-piece” in the context of the disclosure is intended to be understood to refer to elements which are at least partially produced with each other, for example, a vulcanized element. Assembly is intended to be understood to be the installation of the vibration damper in a steering wheel module.

According to a preferred development of the vibration damper, the resilient element comprises a substantially radially inwardly protruding internal flange which is constructed to engage in a circumferentially extending external annular groove of the carrier ring, wherein the resilient element and the carrier ring may thereby form a positive-locking and/or non-positive-locking and gas-tight first connection. The construction of such a connection leads to the internal flange snap-fitting in a simple manner into the external annular groove during assembly of the vibration damper and being prepositioned at that location at least in an axial direction. A significant coverage of the internal flange and external annular groove further leads to a gas-tight connection being able to be produced using simple means. Depending on the embodiment of the contour of the internal flange and external annular groove, they may also cooperate in a labyrinth-like manner, which increases the gas-tightness.

According to another embodiment of the vibration damper according to the invention, it is also conceivable for the resilient element and the carrier ring to form a crimp connection with each other. In this instance, axial forces can be applied to the external annular groove in order to clamp the internal flange between the wall portions of the external annular groove.

According to a development, the internal flange at least partially comprises a free edge which is distally thickened with respect to a flange main member. The thickened free edge consequently forms an undercut in which, after a crimping operation, the external annular groove can engage and release of the resilient element and carrier ring can thereby be safely prevented. This connection also withstands the high loading in the event of an airbag being activated.

According to another embodiment of the vibration damper according to the invention, the resilient element has in the region of the first distal edge thereof a radially external clamping shoulder which is constructed in such a manner that it is non-loaded in a pre-assembly state and, in an assembly state, can be compressed by a diffusor and/or another steering wheel component in order to thereby be able to form a positive-locking and/or non-positive-locking connection. The resilient element can thereby be clamped in a simple manner.

It is conceivable for the vibration damper to comprise a form ring which is arranged in the region of the first distal edge on the resilient element. The form ring may be selected from a material which is more rigid than that of the resilient element. The form ring may be arranged or where applicable clamped at the inner side in the resilient element in order to ensure a dimensional stability of the resilient element during assembly. At the same time, the form ring may act as a counter-bearing for a diffusor and/or another steering wheel component if the clamping shoulder of the resilient element is compressed thereby. The form ring may be arranged at the inner side of the resilient element opposite the clamping shoulder or at least in this region.

According to a development, the vibration damper according to embodiments of the invention may be configured in such a manner that the resilient element forms in the region of the second distal edge thereof a radially internal clamping cone which is constructed in such a manner that it is non-loaded in a pre-assembly state and, in an assembly state, can be acted on with force and/or expanded in a radially outward direction by the carrier ring. The cross section path of the second distal edge may thus be at least partially conical in an axial direction, preferably becoming thicker toward the front side.

It is additionally conceivable for the clamping cone to be constructed to thicken the second distal edge, whereby, at least in the assembly state, a radially external stop cushion is formed. An element which surrounds the vibration damper may strike this cushion in the event of high radial accelerations. The clamping cone thereby prevents impact noises and increases the perception of value of a user. A radial spacing between the vibration damper and surrounding element (such as, for example, a diffusor and/or another steering wheel component) can thereby be selected to be small which leads to not only the vibration damper but also the steering wheel module being able to be constructed to be small. Steering wheels with a small steering wheel hub can thereby be produced, which increases the configuration freedom.

According to a development, the resilient element may form in the region of the first distal edge thereof an annular seal, which is constructed in such a manner that in an assembly state it can be compressed against a module base and/or another steering wheel component in order to thereby be able to form a gas-tight second connection. The annular seal is constructed in a monolithic manner with the resilient element and preferably constructed in an axial direction so that it can be acted on with force in an axial direction by a diffusor and/or another steering wheel component.

According to another embodiment of the vibration damper according to the invention, the carrier ring is constructed and/or arranged in such a manner that, between the first distal edge thereof, which may face in an assembly state a module base and/or another steering wheel component, and a module base and/or another steering wheel component, there is a support distance which in the event of the airbag being actuated may be zero so that a displacement movement of a gas generator is limited. In the event of actuation of the airbag, the gas generator is subjected to an axially directed recoil. By means of appropriate spacing with respect to a module base, when the airbag is actuated an indirect axial support of the gas generator can be carried out via the carrier ring against the module base and/or another steering wheel component. It may be advantageous for an acceleration path of the size of the support distance to be selected to be as small as possible, but greater than zero in order to keep the speed in the event of an impact against the module base and/or against another steering wheel component as small as possible and thus to prevent damage.

According to embodiments of the invention, a vibration damper for a motor vehicle steering wheel, which may comprise a gas generator for a steering wheel airbag as an inertial mass is additionally proposed, wherein the vibration damper comprises a substantially hollow-cylindrical or hollow-frustoconical resilient element which is made of an elastomer material and which can be connected to the motor vehicle steering wheel and/or a motor vehicle steering wheel module, and a carrier ring which is connected to the resilient element and which can be connected to the gas generator, wherein the resilient element is either formed integrally with the carrier ring and these two components thereby form a third connection or the resilient element is constructed integrally with a form ring which is arranged in the region of the first distal edge on the resilient element and these two components thereby form a fourth connection.

According to this vibration damper, both connections are now not formed by means of vulcanization, but instead only one of the connections. If the resilient element is constructed in one piece with the carrier ring, the form ring may be configured as a separate element. If the resilient element is constructed integrally with a form ring, the carrier ring may be configured as a separate element. Consequently, only one additional component still has to be placed in a vulcanization tool, which at least partially simplifies a production process compared with known processes.

It is additionally conceivable to develop this second vibration damper mentioned according to one or more of the above-described paragraphs. The advantages which have already been set out above with respect to the vibration damper are also afforded in a similar manner for this vibration damper, for which reason reference is made thereto.

### BRIEF DESCRIPTION OF THE DRAWINGS

Other features, details and advantages of embodiments of the invention will be appreciated from the wording of the claims and from the following description of embodiments with reference to the schematic drawings, in which:

FIG. 1 shows a plan view of a steering wheel module having a vibration damper according to an embodiment of the invention,

FIG. 2 shows a sectioned view of the steering wheel module according to FIG. 1 along a line II-II in FIG. 1,

FIG. 3 shows a detailed view of the steering wheel module according to FIG. 2,

FIG. 4 shows a further enlarged detailed view of the steering wheel module according to FIG. 3,

FIG. 5 shows a sectioned view of another vibration damper, and

FIG. 6 shows a sectioned view of another vibration damper.

### DETAILED DESCRIPTION

In the Figures, identical or corresponding elements are each given the same or similar reference numerals and are therefore, unless advantageous, not described again. The disclosures contained in the entire description can be transferred correspondingly to identical components with the same reference numerals or same component names. The position indications selected in the description, such as, for example, top, bottom, laterally, etcetera, also relate to the Figure described and illustrated directly and in the event of a position change should be transferred correspondingly to the new position. Furthermore, individual features or feature combinations from the different embodiments shown and described may also represent solutions which are independent, inventive or in accordance with embodiments of the invention per se.

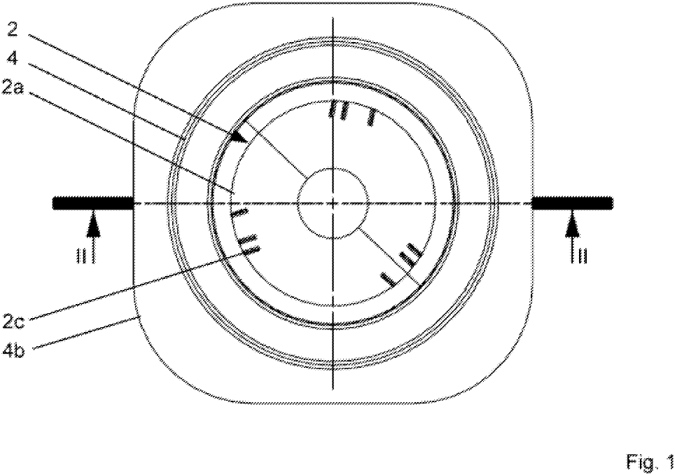

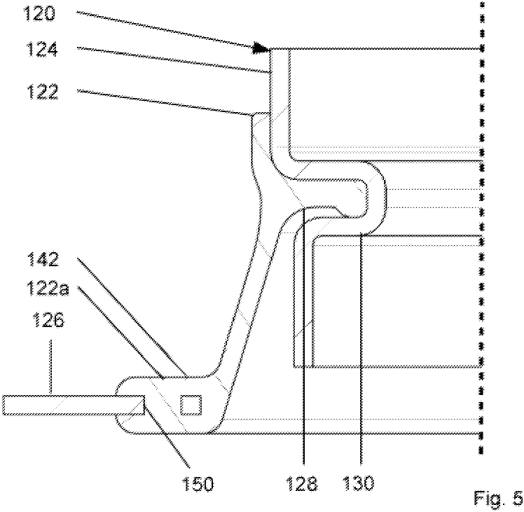

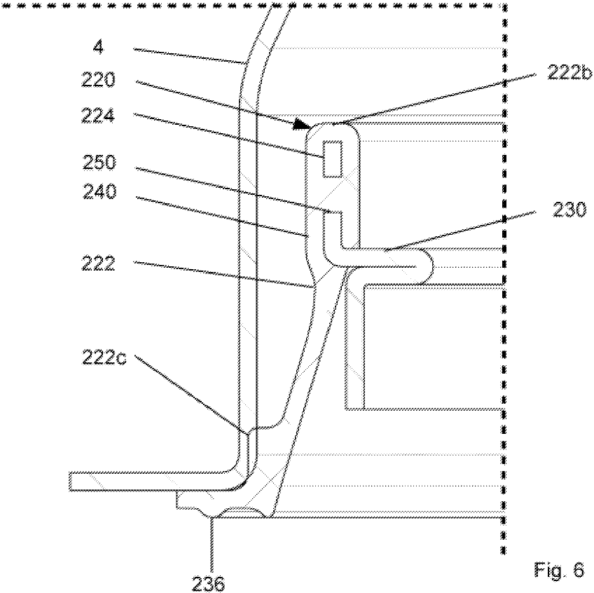

Although the Figures show the vibration damper according to embodiments of the invention in the context of the installation situation thereof, the advantages according to embodiments of the invention are achieved exclusively by the vibration damper per se. FIGS. 1 to 4 show a first vibration damper, whilst FIG. 5 shows a second and FIG. 6 shows a third vibration damper.

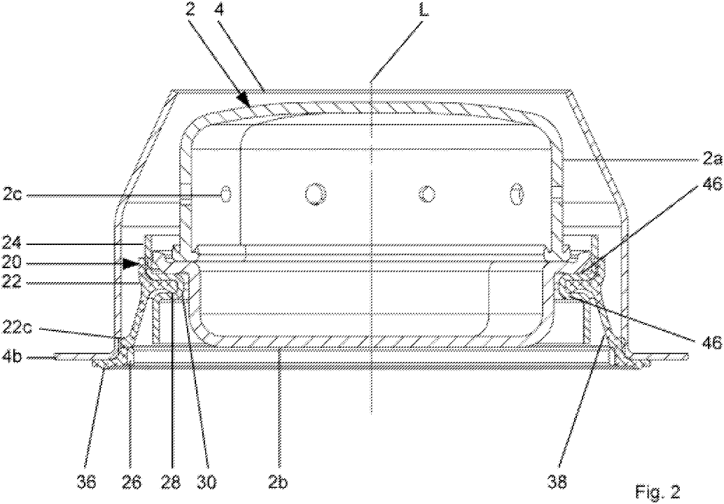

FIGS. 1 and 2 show an overall view of a steering wheel module with the vibration damper 20 according to embodiments of the invention. This steering wheel module also comprises in addition to the vibration damper 20 an airbag with a gas generator 2 and can be covered by means of a plastics material bag which is not illustrated and which in the event of the airbag being activated can be blown up by means of gas flowing out of the gas generator 2. The gas generator 2 comprises an upper shell 2a and a lower shell 2b which is connected or welded thereto. The upper shell 2a has gas passage openings 2c through which a gas can flow from the generator 2 into the plastics material bag in order to blow it up. The generator 2 is surrounded by a diffusor 2, which has gas outlet openings and a diffusor collar 4b which are not illustrated. The diffusor 4 is closed at least partially in a dome-like manner in the upper region thereof but, for schematic reasons, it is illustrated in the open state.

FIG. 2 now shows that the vibration damper 20 for a motor vehicle steering wheel comprises the gas generator 2 as an inertial mass. The vibration damper 20 has a substantially hollow-cylindrical or hollow-frustoconical resilient element 22 made of an elastomer material, wherein the resilient element is a separate element and can be produced by means of vulcanization. A cylindrical carrier ring 24 is connected to the resilient element 22 by means of a first connection 40. The carrier ring 24 can be securely connected to the gas generator 2 or one or both of the shells 2a, 2b thereof and also acts as an inertial mass. More precisely, the lower shell 2b can be securely connected to an external annular groove 30 of the carrier ring 24 by the second distal edge 24b of the carrier ring 24 being flanged radially inwardly and engaging over and securely clamping a lower shell flange 2d. FIGS. 1 to 4 form a state prior to flanging. To this end, the lower shell flange 2d is located on the wall portion 46 of the external annular groove 30 facing the plastics material bag. The lower shell flange 2d is thereby supported in the event of the airbag being activated against the external annular groove 30 and also carries it in an axial direction.

In order to form the first connection 40, the resilient element 22 has an internal flange 28 which protrudes substantially radially inwardly. The internal flange 28 comprises at least partially a free edge 34 which is distally thickened with respect to a flange main member 32, whereby an undercut 44 is formed. In addition, the carrier ring 24 has the external annular groove 30 which extends at the circumference and in which the internal flange 28 engages. The resilient element 22 and the carrier ring 24 may together form a crimp connection, wherein the resilient element 22 and the carrier ring 24 thereby form the positive-locking and/or non-positive-locking and gas-tight first connection 40. FIGS. 1 to 4 show a state prior to crimping. For crimping, a force which acts parallel with the longitudinal axis L or two forces which are directed in opposite directions and which act parallel with the longitudinal axis L are applied to the external annular groove 30 at least in regions so that the wall portions 46 thereof are deformed at least in areas and permanently clamp the external annular groove 30.

It can be seen that the resilient element 22 and the carrier ring 24 are in the form of separate components and the resilient element 22 is in the form of a monolithic molded rubber component.

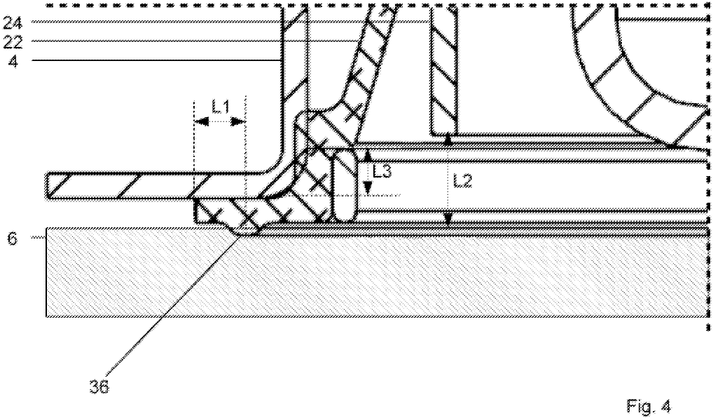

A form ring 26 is inserted at the end side or in the region of the first distal edge 22a at the inner side into the resilient element 22. To this end, the resilient element 22 has a recess which corresponds to the form ring 26, wherein the form ring 26 is pressed in at that location and is used for the form stabilization of the resilient element 22. In this region, the resilient element 22 has at the outer side a radially external clamping shoulder 22c. The clamping shoulder 22c is constructed in such a manner that it is non-loaded in a pre-assembly state and can be compressed by the diffusor 4 in an assembly state in order to thereby be able to form a positive-locking and/or non-positive-locking connection. In particular, FIG. 4 shows that in the assembly state an axial covering L3 is formed between the diffusor 4 and the form ring 26.

The resilient element 22 additionally has in the region of the first distal edge 22a thereof a monolithic annular seal 36 which is constructed in such a manner that in an assembly state it can be compressed against a module base 6 and/or another steering wheel component. The resilient element additionally has at the first distal edge 22a thereof a lever portion 22f which protrudes circumferentially in a radial direction and which radially overlaps the annular seal 36. A lever arm L1 is thereby formed between the circumferential edge of the lever portion 22f and the annular seal 36 in a radial direction. In order to form a gas-tight second connection 42, the diffusor collar 4b can now press against the distal edge 22a and consequently press the annular seal 36 onto the module base 6. The resilient element 22 is thus clamped between the diffusor 4 and the form ring 26. As a result of the first connection 40 and the second connection 42, a gas-tight inner space 38 is formed.

The resilient element 22 forms in the region of the second distal edge 22b thereof a radially internal clamping cone 22d which is constructed in such a manner that it is non-loaded in a preassembly state and, in an assembly state, can be acted on with force and/or expanded in a radially outward direction by the carrier ring 24 or the second distal edge 24b thereof. The clamping cone 22d is constructed in such a manner that it thickens the second distal edge 22b in the direction toward the front side, whereby at least in the assembly state a radially external stop cushion 22e is formed. The stop cushion has in a radial direction a radial spacing R with respect to the surrounding diffusor 4.

The carrier ring 24 is arranged in such a manner that in the assembly state between the first distal edge 24a thereof and the module base 6 there is a support spacing L2 which is greater than zero and which, in the event of the airbag being activated, may be zero so that a displacement movement of a gas generator 2 and the carrier ring 4 is limited.

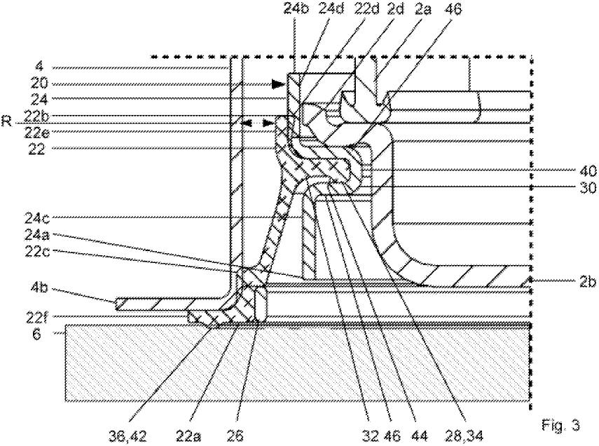

FIG. 5 shows a cut-out of another vibration damper 120 for a motor vehicle steering wheel, wherein the cut-out of FIG. 5 is in principle similar to the cut-out of FIG. 3. The steering wheel may comprise a gas generator which is not shown for a steering wheel airbag as an inertial mass. The vibration damper 120 comprises a substantially hollow-cylindrical or hollow-frustoconical resilient element 122 which is made of an elastomer material and which can be connected to the motor vehicle steering wheel and/or a motor vehicle steering wheel module. In addition, the vibration damper 120 comprises a carrier ring 124 which is connected to the resilient element 122 and which in turn can be connected to the gas generator. The resilient element 122 is formed by means of vulcanization and in this instance in one piece with a form ring 126 which is vulcanized on the resilient element 122 in the region of the first distal edge 122a. To this end, the form ring 126 has positive-locking holes 150 which are arranged in the material of the resilient element 122. These two components 122, 126 thereby form a fourth gas-tight connection 142. Via the form ring 126, the vibration damper 120 may be connected to a module base, wherein the gas-tight connection is produced between the first distal edge 122a and the module base. Another gas-tight connection can be formed by means of crimping between an internal flange 128 and an external annular groove 130.

FIG. 6 shows a cut-out of another tuned mas damper 220 for a motor vehicle steering wheel, wherein the cut-out of FIG. 6 is also in principle similar to the cut-out of FIG. 3. The steering wheel may comprise a gas generator which is not shown for a steering wheel airbag as an inertial mass. The vibration damper 220 comprises a substantially hollow-cylindrical or hollow-frustoconical resilient element 222 which is made of an elastomer material and which can be connected to the motor vehicle steering wheel and/or a motor vehicle steering wheel module. In addition, the vibration damper 220 comprises a carrier ring 224 which is connected to the resilient element 222 and which in turn can be connected to the gas generator. The resilient element 222 is formed by means of vulcanization and in this instance integrally with the carrier ring 224 which is vulcanized on the resilient element 222 in the region of the second distal edge 222b. To this end, the carrier ring 224 has positive-locking holes 250 which are arranged in the material of the resilient element 222. These two components 222, 224 thereby form a third gas-tight connection 240. Another gas-tight connection forms an annular seal 236 which can be pressed onto a module base, wherein this seal can be acted on with pressure by means of the diffusor 4 which adjoins a clamping shoulder 222c. The carrier ring 224 has an external annular groove 230 for supporting the gas generator.

The invention is not limited to one of the above-described embodiments but can instead be modified in many ways. All of the features and advantages which are derived from the claims, the description and the drawings, including structural details, spatial arrangements and method steps, may be significant to the invention both per se and in extremely varied combinations. The scope of the invention includes all combinations of at least two of the features disclosed in the description, the claims and/or the Figures. In order to prevent repetition, features disclosed in accordance with the apparatus should also be considered to be disclosed in accordance with the method and be able to be claimed. Features disclosed in accordance with the method should also be considered to be disclosed in accordance with the apparatus and be able to be claimed.

1. A vibration damper for a motor vehicle steering wheel with a gas generator for a steering wheel airbag as an inertial mass, the vibration damper comprising:
a substantially hollow-cylindrical or hollow-frustoconical resilient element which is made of an elastomer material and which can be connected to the said motor vehicle steering wheel and/or a motor vehicle steering wheel module, and
a carrier ring which is connected to the resilient element and which can be connected to said gas generator,
wherein the resilient element and the carrier ring are separate components and/or the resilient element is a monolithic molded rubber component.

2. The vibration damper as claimed in claim 1, wherein the resilient element comprises a substantially radially inwardly protruding internal flange configured to engage in a circumferentially extending external annular groove of the carrier ring, and wherein the resilient element and the carrier ring thereby form a positive-locking and/or non-positive-locking and gas-tight first connection.

3. The vibration damper as claimed in claim 1, wherein the resilient element and the carrier ring form a crimp connection with each other.

4. The vibration damper as claimed in claim 2, wherein the internal flange at least partially comprises a free edge which is distally thickened with respect to a flange main member.

5. The vibration damper as claimed in claim 1, wherein the resilient element has in a region of the a first distal edge thereof a radially external clamping shoulder configured in such a manner that the radially external clamping shoulder is non-loaded in a pre-assembly state and, in an assembly state, can be compressed by a diffusor and/or another steering wheel component to form a positive-locking and/or non-positive-locking connection.

6. The vibration damper as claimed in claim 1, having a form ring which is arranged in a region of a first distal edge on the resilient element.

7. The vibration damper as claimed in claim 1, wherein the resilient element forms in a region of a second distal edge thereof a radially internal clamping cone configured in such a manner that the radially internal clamping cone is non-loaded in a pre-assembly state and, in an assembly state, can be acted on with force and/or expanded in a radially outward direction by the carrier ring.

8. The vibration damper as claimed in claim 7, wherein the clamping cone is constructed to thicken the second distal edge, whereby, at least in the assembly state, a radially external stop cushion is formed.

9. The vibration damper as claimed in claim 1, wherein the resilient element forms in a region of a first distal edge thereof an annular seal configured in such a manner that in an assembly state the annular seal can be compressed against a module base and/or another steering wheel component to thereby form a gas-tight second connection.

10. The vibration damper as claimed in claim 1, wherein the carrier ring is constructed and/or arranged in such a manner that, between a first distal edge thereof, which may face in an assembly state a module base and/or another steering wheel component and a module base and/or another steering wheel component, there is a support distance which in the event of the airbag being actuated may be zero so that a displacement movement of a gas generator is limited.

11. A vibration damper for a motor vehicle steering wheel with a gas generator for a steering wheel airbag as an inertial mass, the vibration damper comprising:
a substantially hollow-cylindrical or hollow-frustoconical resilient element is made of an elastomer material and which can be connected to said motor vehicle steering wheel and/or a motor vehicle steering wheel module, and
a carrier ring which is connected to the resilient element and which can be connected to the gas generator, wherein the resilient element is either formed integrally with the carrier ring and these two components thereby form a third connection or the resilient element is constructed integrally with a form ring arranged in a region of a first distal edge on the resilient element and these two components thereby form a fourth connection.
